(19) United States
(12) Patent Application Publication
(10) Pub. No.: US 2012/0292073 A1
(43) Pub. Date: Nov. 22, 2012

(54) HIGH-VOLTAGE BUSHING

(75) Inventors: Engelbert Engels, Koeln (DE); Michael Koch, Koeln (DE); Achim Langens, Lohmar (DE)

(73) Assignee: SIEMENS AKTIENGESELLSCHAFT, Muenchen (DE)

(21) Appl. No.: 13/522,360

(22) PCT Filed: Jan. 7, 2011
(86) PCT No.: PCT/EP2011/050148

§ 371 Date: Jul. 16, 2012

(30) Foreign Application Priority Data
Jan. 15, 2010 (DE) 10 2010 005 086.5

(51) Int. Cl. H02G 15/00; H01B 7/00

(52) U.S. Cl. 174/73.1; 174/120 R

(57) ABSTRACT

An improved high-voltage duct has an electrically insulated winding body extending in a longitudinal direction and contains electrically conductive inserts wound about a winding core. The inserts are spaced apart from each other by insulation layers soaked in resin. A high-voltage conductor extends as a winding core in the winding body. A fastening flange is mounted on the winding body in a fastening area of the flange for assembly of the high-voltage duct, such that the duct can also be used for DC levels above 550 kV. Accordingly, the winding body contains different thicknesses in the fastening area thereof, so that areas of changes in diameter are configured in which the winding body contains different diameters at different locations along in a longitudinal direction thereof.

The invention relates to a high-voltage bushing having an electrically insulating winding body which extends in a longitudinal direction and has electrically conducting inserts wound on a winding core, said inserts being spaced apart from one another by insulation layers impregnated in resin, a high-voltage conductor extending as a winding core in the winding body, and a fixing flange attached to the winding body in a fixing area thereof for installation of the high-voltage bushing.

Such a high-voltage bushing is already known from DE 32 26 057 A1. The high-voltage bushing shown therein has a high-voltage conductor which extends through an electrically insulating winding body. A fixing flange, which surrounds the winding core so as to clamp it, is used for fixing the whole high-voltage bushing to the boundary wall of a through-opening. In order to dissipate high electrical field strengths, the winding body has potential control inserts which are electrically conducting, wherein the potential control inserts are spaced apart from one another by insulation layers impregnated in resin. Such a high-voltage bushing is also referred to as a capacitor bushing. It is used mainly to feed a high electrical voltage through a wall which is at ground potential.

Associated with the high-voltage bushings disclosed in the prior art is the disadvantage that they can only be sized in such a way that they can be used at DC levels up to 550 kV. The windings which can be produced in accordance with the prior art already have a resin mass of 1500 to 2000 kg. In order to make higher voltages controllable, even greater clearances must be maintained. However, the consequence of this is even larger and therefore heavier winding bodies. With high-voltage bushings according to the prior art, their mounting brackets would be affected by cracks and other undesirable side-effects, particularly due to the high inherent weight of such winding bodies, so that they would be impossible to use in practice.

The object of the invention is therefore to improve a high-voltage bushing of the kind mentioned in the introduction in such a way that it can also be used for DC voltage levels of greater than 550 kV.

The invention achieves this object in that the winding body has different thicknesses in its fixing region, thus forming diameter change regions in which the winding body has different diameters at different positions in its longitudinal direction.

The high-voltage bushing according to the invention has a winding body with diameter change regions. The diameter change regions lie in a fixing region of the winding body with which the fixing flange mechanically engages. As a result of the diameter change regions, the winding body no longer presses against the circumferential edge of the fixing flange. Rather, this results in a transmission of force between fixing flange and winding body which is spread over a larger area compared with the prior art, so that a heavier winding body can also be mechanically held by the fixing flange without difficulty.

According to a preferred embodiment of the invention, the fixing flange is complementary in shape to the diameter change regions. If, for example, the diameter change regions are in the form of steps, wherein, in a cross-sectional view of the winding body, steps are formed at the outer circumference of the winding body, at its inner side which rests clamped to the winding body, the fixing flange also likewise has a step-shaped inner contour, which in the assembled state engages with the steps of the winding body. A transmission of force between fixing flange and winding body which is spread over an even larger area is provided by this complementarily shaped design.

Expediently, the fixing flange is attached to the fixing body by clamping.

According to a preferred embodiment of the invention, at least one diameter change region forms at least one chamfer in a cross-sectional view of the high-voltage bushing. A chamfer provides a particularly smooth transmission of force between fixing flange and winding body, as sharp edges are completely avoided. Alternative embodiments of the diameter change region are a step-shaped embodiment or similar, for example.

Expediently, at least some sections of the high-voltage conductor are made of aluminum. Compared with copper, aluminum has a lower density, so that, in spite of large dimensions, the high-voltage bushing designed in this way is lighter, and fewer forces due to the weight have to be absorbed by the fixing flange.

According to a preferred embodiment of the invention, an outer housing, into which the winding body partially extends, is provided. Expediently, an outdoor connection, on which an outdoor dissipation device for dissipating high electrical field strengths is located, is formed on the outer housing.

Expediently, the winding body according to the invention has a length of greater than 7000 mm and a diameter of more than 500 mm.

Further expedient embodiments and advantages of the invention are the subject matter of the following description of exemplary embodiments of the invention with reference to the figures of the drawing, wherein the same references refer to identically acting components, and wherein

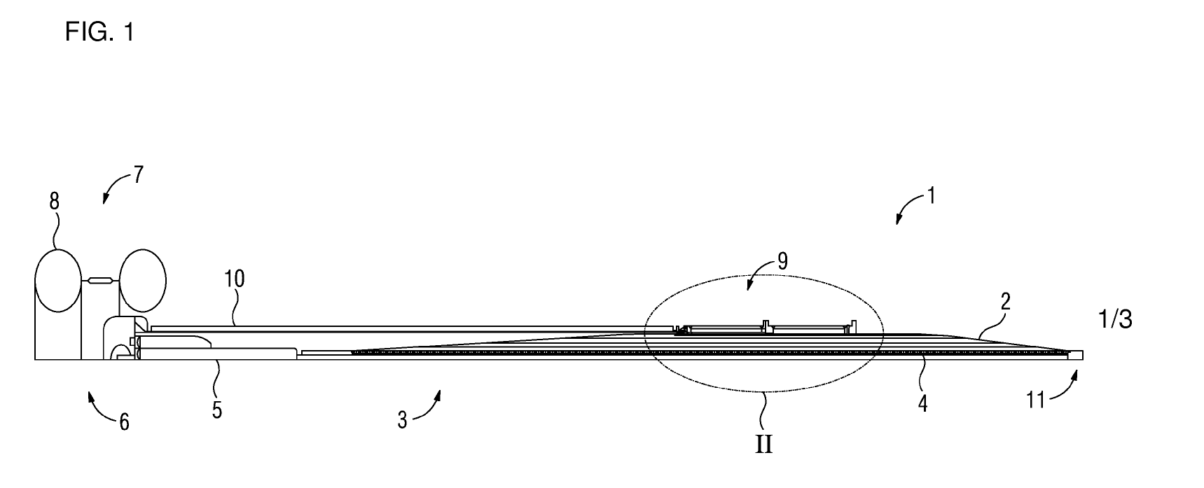

FIG. 1 shows a part of an exemplary embodiment of a high-voltage bushing according to the invention in a cross-sectional view,

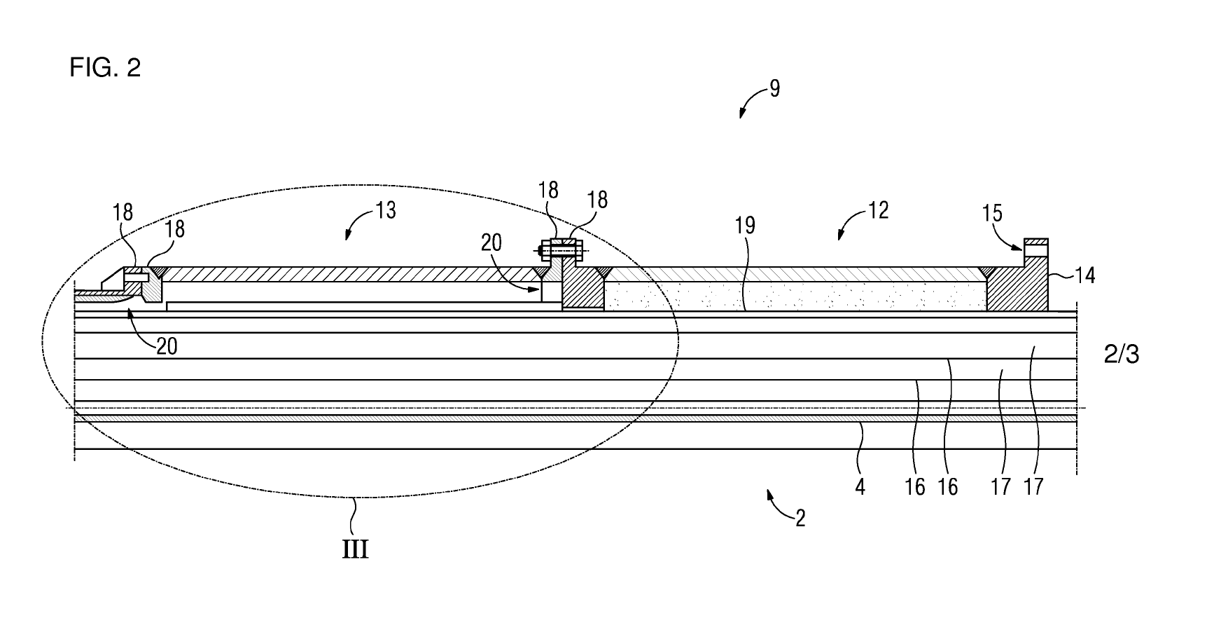

FIG. 2 shows the fixing region of the winding body of the high-voltage bushing according to FIG. 1, and

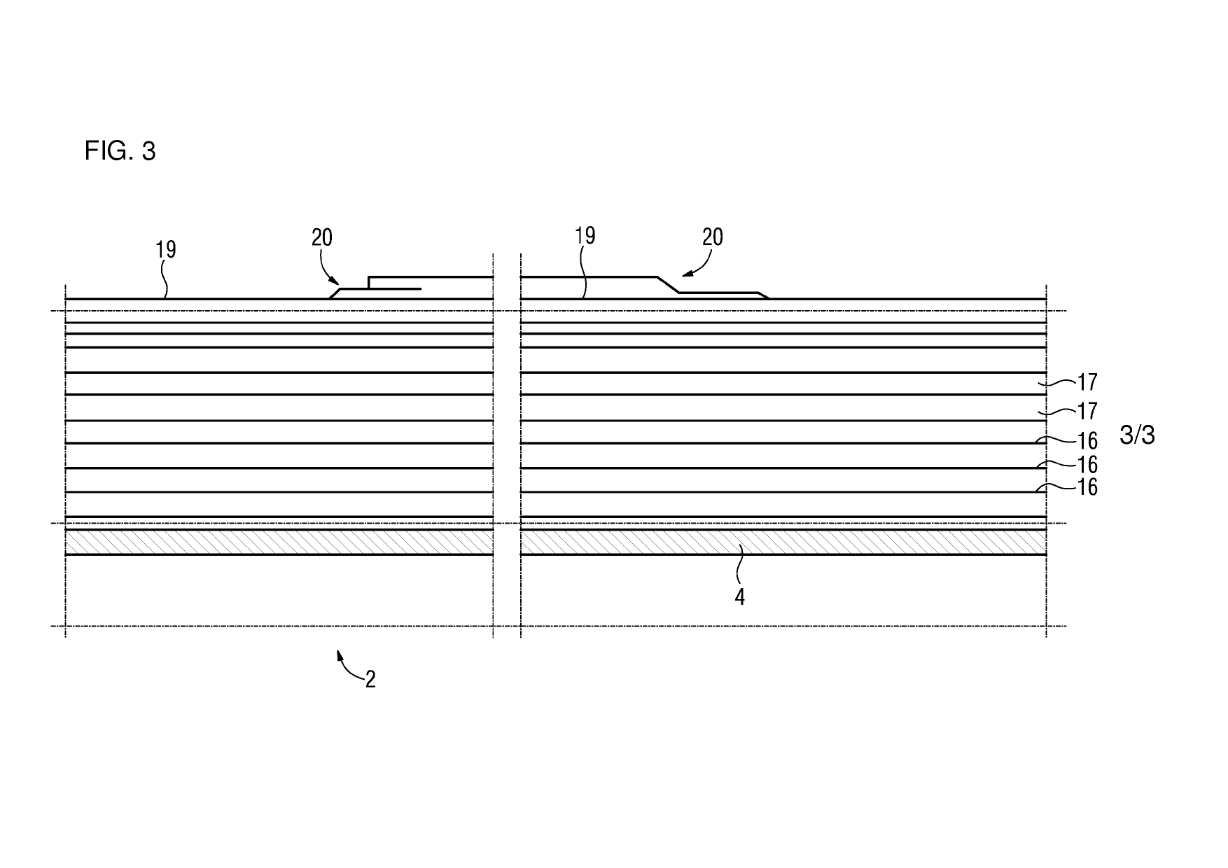

FIG. 3 shows an enlarged view of the fixing region according to FIG. 2 without fixing flange.

FIG. 1 shows in cross section the upper part of an exemplary embodiment of a high-voltage bushing 1 according to the invention which has a winding body 2 and a high-voltage conductor 3. The high-voltage conductor 3 extends centrally through the electrically insulating winding body 2 in a longitudinal direction. At the same time, the high-voltage conductor 3 is tubular and hollow inside and has a copper section 4 arranged in the winding body 2 and an aluminum section 5 which extends from the winding body 2 to an outdoor end 6. An outdoor dissipation device 7 is provided at the outdoor end 6. The outdoor dissipation device 7 has two dissipating rings 8 which are electrically connected to the aluminum section 5 and are used to dissipate high electrical field strengths.

In order to fix the high-voltage bushing 1, the winding body 2 is securely clamped to a fixing flange 9 which extends in the form of a ring around the winding body 2. An outer housing 10 extends from the fixing flange 9 to the outdoor end 6, wherein the outer housing 10 only has external ribs, which can hardly be seen in FIG. 1, to increase a creepage current path. In the exemplary embodiment shown, the outer housing 10 comprises a glass filament/epoxy resin tube with silicone coating.

A transformer end 11, to which field control elements are likewise attached but which are not shown in the figure, is formed on the side of the high-voltage bushing 1 which faces away from the outdoor end 6.

FIG. 2 shows the region bordered by the dashed line in FIG. 1 in an enlarged view. It can be seen that the fixing flange 9 is made up of a transformer-side section 12 and an outdoor-side section 13. The transformer-side section 12 has a transformer fixing ring 14 with set holes 15 which enable the high-voltage bushing 1 to be screwed to a wall in which a through-opening is formed. At the same time, the winding body 2 and therefore the high-voltage conductor 3 extends through the through-opening of the wall, which is at ground potential, wherein the winding body 2 provides the necessary insulation to prevent voltage flashovers. Electrically conducting inserts 16, which were wound as a winding core onto the high-voltage conductor 3 together with non-electrically-conducting insulating layers 17, for example paper or a felt material, are used to dissipate the high electrical field strengths. The paper or felt material was subsequently impregnated in liquid resin. After the resin has hardened, an electrically insulating and mechanically stable winding body 2, which is designed for high direct voltages of greater than 800 kV and has a length of 10,000 mm, a diameter of 600 mm and a weight of 4500 kg, is produced.

It can also be seen from FIG. 2 that the transformer-side section 12 is connected to the outdoor section 13 by means of connecting rings 18. The surface region, with which the winding body 6 rests against the fixing flange 9, is here designated as fixing region 19. Furthermore, it can be seen that the outer housing 10 is also connected to the fixing flange 9 and the winding body 2 by means of connecting rings 18.

As can be seen particularly from FIG. 3, which shows a region which is bordered by a dashed line in FIG. 2, diameter change regions 20 in which the thickness of the winding body 2 changes in the longitudinal direction are formed in the fixing region 19.

In the exemplary embodiment shown in FIG. 3, the diameter change regions 20 are in the form of steps, wherein the steps have chamfers. The fixing section 19 and the outer housing 10 are complementary in shape to the diameter change regions 20 so that the forces are transmitted between winding body 2 and fixing flange 9 over a large area via the chamfers. This prevents high bending forces at the edges of the fixing flange 9.

1-8. (canceled)

9. A high-voltage bushing, comprising:
a high-voltage conductor extending as a winding core;
electrically insulating winding body extending in a longitudinal direction and having electrically conducting inserts wound on said winding core, said electrically conducting inserts being spaced apart from one another by insulation layers impregnated in resin;
a fixing flange attached to said electrically insulating winding body in a fixing region for installation of the high-voltage bushing; and
said electrically insulating winding body having different thicknesses in said fixing region, thus forming diameter change regions in which said electrically insulating winding body having different diameters at different positions in said longitudinal direction.

10. The high-voltage bushing according to claim 9, wherein said fixing flange is complementary in shape to said diameter change regions.

11. The high-voltage bushing according to claim 9, wherein said fixing flange is fixed to said electrically insulating winding body by clamping.

12. The high-voltage bushing according to claim 9, wherein at least one of said diameter change regions forms at least one chamfer in a cross-sectional view of the high-voltage bushing.

13. The high-voltage bushing according to claim 9, wherein at least some sections of said high-voltage conductor are made of aluminum.

14. The high-voltage bushing according to claim 9, further comprising an outer housing into which said electrically insulating winding body partially extends.

15. The high-voltage bushing according to claim 14, further comprising an outdoor dissipation device for dissipating high electrical field strengths at an end facing away from said electrically insulating winding body, said outer housing having an outdoor connection with said outdoor dissipation device.

16. The high-voltage bushing according to claim 9, wherein said electrically insulating winding body has a length of greater than 7,000 mm and a diameter of more than 500 mm.
